(19) United States
(12) Patent Application Publication
(10) Pub. No.: US 2017/0330405 A1
(43) Pub. Date: Nov. 16, 2017

(54) PRIZE DISCHARGE MECHANISM

(71) Applicant: Konami Digital Entertainment Co., Ltd., Tokyo (JP)

(72) Inventors: Satoshi UEDA, Minato-ku (JP); Hiroyuki TAKADA, Minato-ku (JP); Yuse KINOSHITA, Minato-ku (JP); Takafumi SAKAI, Minato-ku (JP); Kojiro MINAMI, Minato-ku (JP); Shota NAKAYAMA, Minato-ku (JP)

(21) Appl. No.: 15/669,754

(22) Filed: Aug. 4, 2017

Related U.S. Application Data
(63) Continuation of application No. PCT/JP2016/053376, filed on Feb. 4, 2016.

(30) Foreign Application Priority Data
Feb. 10, 2015 (JP) 2015-024754

(51) Int. Cl. G07F 17/32; G07F 11/52

(52) U.S. Cl. CPC G07F 17/32; G07F 11/52

(57) ABSTRACT

Provided is a prize discharge mechanism that can manage the remaining number of prizes, including the stock to be discharged not only for the next discharge but also for subsequent discharges. A prize discharge mechanism is provided with the following: a delivery disk that includes six passage opening parts through which capsules pass, that is disposed so that from among these, a connection passage opening part corresponds to the position of an upper-side discharge port, and that with rotation, delivers the capsules; a bottom surface disk that includes a connection opening part through which the capsules pass, and that is disposed between the delivery disk and the upper-side discharge port so that, while blocking other than the connection passage opening part, the connection opening part corresponds to the position of the upper-side discharge port; and five sensors that detect the capsules of the remaining five passage opening parts.

### CROSS-REFERENCE TO RELATED APPLICATION

This application is a continuation of PCT Patent Application No. PCT/JP2016/053376, filed Feb. 4, 2016 which claims priority to JP Patent Application No. 2015-024754, filed Feb. 10, 2015, the disclosures of which are hereby incorporated by reference in their entirety.

### TECHNICAL FIELD

The present invention relates to a prize discharge mechanism that discharges a plurality of prizes which is accumulated inside an accumulation part from a discharge port one by one, and so on.

### BACKGROUND ART

Prize discharge mechanisms already exist that discharges a plurality of prizes which is accumulated inside an accumulation part from a discharge port one by one. Further, as the plurality of prizes, prizes with capsule shapes which store various things in the inside may be used. As one of such prize discharge mechanisms, there is known a capsule discharge device that has each tube body in which capsules line up longitudinally, discharges the capsule of lowermost position of each tube body sequentially, and detects the presence of the capsule of lowermost position (for example, refer to Patent Document #1). Apart from this, as Prior Art Documents relating to the present invention, there are Patent Document #2 and Patent Document #3.

### CITATION LIST

### Patent Literature

Patent Document #1: Japanese Patent Publication 3068004.

Patent Document #2: Japanese Patent Publication 4821103.

Patent Document #3: Japanese Patent Publication 4204287.

### SUMMARY OF INVENTION

### Technical Problem

In Patent Document #1, the presence of the capsule of lowermost position is detected for each tube body. That is, it is detected whether or not each tube body can discharge the capsule next time. On the other hand, discharge mechanisms also exist that with collection of consideration and so on, discharge a capsule one by one by rotating a delivery disk having disk shape via the rotation (so-called Gacha system or capsule toy machine). In such the discharge mechanisms, consideration is often collected by prepayment. In the prepayment case, if it is impossible to discharge the capsule, it is needed to return the consideration. However, it is often difficult to return the consideration, for example when electronic currency is used as the consideration, and so on. Therefore, similarly, in such the discharge mechanisms, it also may be needed to manage whether or not it is possible to discharge the capsule next time. Furthermore, it may be insufficient to check only the number of capsule stocks which can be discharged next time.

Accordingly, it is an object of the present invention to provide a prize discharge mechanism and so on that manages the number of prize stocks including stocks which will be discharged not only next time but also after that.

### Solution to Technical Problem

A prize discharge mechanism of the present invention is a prize discharge mechanism that discharges a plurality of prizes which is accumulated inside an accumulation part from a discharge port one by one, wherein the prize discharge mechanism comprises: a first member configured to have a plurality of passage opening parts with size at which the plurality of prizes passes one by one, and be arranged so that one passage opening part among the plurality of passage opening parts corresponds to a position of the discharge port, a second member configured to have a connection opening part opening so that each prize passes, be arranged between the first member and the discharge port so that the connection opening part corresponds to the position of the discharge port, and block remaining passage opening parts other than the one passage opening part so that each prize does not pass and stays in there; a restriction member configured to restrict entry of each prize to the one passage opening part; and a plurality of prize detection sensors configured to execute detection of whether or not each prize stays, for at least a part of the remaining passage opening parts, and wherein the first member rotates along the second member with a prize which stays in each passage opening part so that each passage opening part functions as the one passage opening part sequentially, and the plurality of prize detection sensors execute, among the remaining passage opening parts, the detection for at least the two passage opening parts which will function as the one passage opening part at next time and at time after next sequentially with a rotation of the first member.

### BRIEF DESCRIPTION OF DRAWINGS

FIG. 1 is a figure schematically showing the external appearance of a game system including a prize discharge mechanism according to an embodiment of the present invention and a game machine using it;

FIG. 2 is a figure showing the principal portions of the control system of the prize discharge mechanism and the game machine;

FIG. 3 is a figure schematically showing an example of a perspective view of an accumulation part in which the front side cover and the upper side cover are removed;

FIG. 4 is a figure schematically showing a front view in the example of FIG. 3;

FIG. 5 is a figure schematically showing a left side view in the example of FIG. 3;

FIG. 6 is a figure schematically showing a cross-section view about VI-VI line in FIG. 4;

FIG. 7 is a figure schematically showing the accumulation part in which a wall part is removed in the example of FIG. 3;

FIG. 8 is a figure schematically showing the plane view of the accumulation part in the example of FIG. 7;

FIG. 9 is a figure showing an example of a flow chart of a delivery processing routine; and

FIG. 10 is a figure showing an example of a flow chart of a position adjustment processing routine.

### DESCRIPTION OF EMBODIMENTS

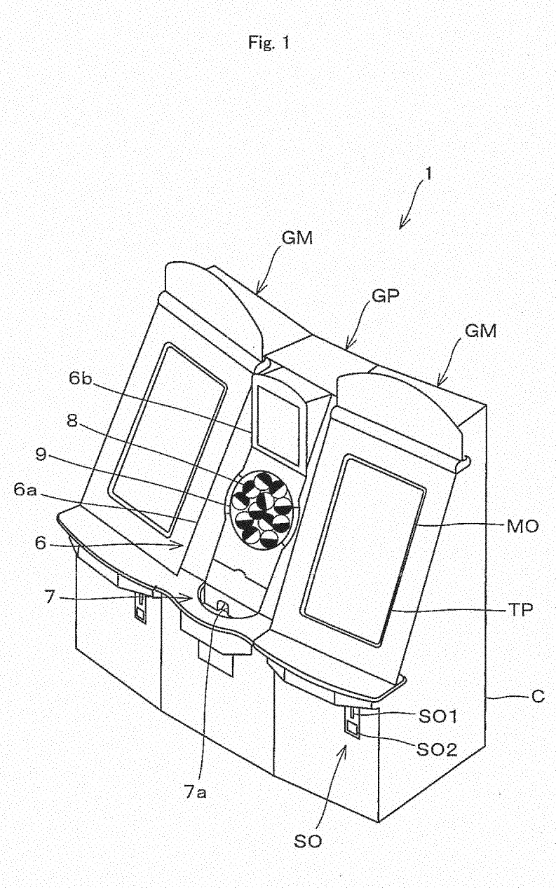

In the following, a prize discharge mechanism according to an embodiment of the present invention will be explained. FIG. 1 is a figure schematically showing the external appearance of a game system including a prize discharge mechanism according to an embodiment of the present invention and a game machine using it. As shown in FIG. 1, as one example, the game system 1 includes the prize discharge mechanism GP and two game machines GM.

The prize discharge mechanism GP is a mechanism for supplying users with prizes which are accumulated in the inside. As one example, the prize discharge mechanism GP is connected to these two game machines GM, and used. The prize discharge mechanism GP comprises, for example, an accumulation part 6 and a discharge part 7. The accumulation part 6 is a part for accumulating a plurality of prizes. For example, a plurality of capsules 8 serving as prizes is accumulated in the accumulation part 6.

A front side cover 6a is provided at the front side of the accumulation part 6. And, an upper side cover 6b is provided at the upper side of the accumulation part 6. The front side cover 6a and the upper side cover 6b are cover members for forming the front side or the upper side of the accumulation part 6. In the inside of the accumulation part 6, space is formed by the front side cover 6a and the upper side cover 6b. As one example, a steric window with a dome shape is provided on the front side cover 6a. Therefore, the accumulation part 6 provides information of the capsules 8 in the inside visually, to outside through the window 9. Each capsule 8 is a spherical case of capsule type which stores one of various kinds of physical benefits (objects) such as a figure and so on, in the inside. That is, actual benefits (prizes) are stored in the capsules 8.

On the other hand, the discharge part 7 is a part for supplying users with prizes inside the accumulation part 6. A downside discharge port 7a is formed in the discharge part 7. The downside discharge port 7a is connected to a connection path (not shown). The connection path is a path which connects the inside to the outside of the accumulation part 6. That is, the downside discharge port 7a is an opening which connects the inside to the outside of the accumulation part 6 via the connection path. And, the capsules 8 inside the accumulation part 6 are discharged to the discharge part 7 (outside) via the downside discharge port 7a. In concrete terms, the prize discharge mechanism GP discharges each capsule 8 inside the accumulation part 6 to the outside one by one from the downside discharge port 7a, when a prize condition is met. As one example, in this manner, the prize discharge mechanism GP is configured as a vendor unit which appropriately supplies users with the capsules 8 inside the accumulation part 6 (so-called Gacha system or capsule toy machine).

On the other hand, as one example, the game machine GM is configured as a game machine for business use (i.e. for commercial use). A game machine for business use is a game machine that allows users to play a game within a range for a fee or without a fee. As one example, the game machine GM provides a game for a fee. In concrete terms, for example, in exchange for spending of a predetermined consideration, the game machine GM provides a game using the prize discharge mechanism GP within a range corresponding to that consideration. An appropriate number of the game machines GM are installed in a commercial facility such as an arcade or the like.

The game machine GM has a chassis C. A monitor MO is provided in the chassis C. A transparent touch panel TP is overlaid over the surface of the monitor MO. The touch panel TP is a per se known input device that outputs a signal corresponding to the position of the contact of finger or the like. A coin collection mechanism SO is provided at the front side of the chassis C. The coin collection mechanism SO is a mechanism for executing collection, return of coins, and so on. The coin collection mechanism SO has a coin input port SO1 and a coin discharge port SO2. The coin input port SO1 is used for inputs of coins. And, the coin discharge port SO2 is used for discharges of coins. Further, as one example, a predetermined consideration is consumed (paid) via the coins. It should be understood that, in addition to the above, the game machine GM may be provided with input devices and output devices of various types that are equipped to conventional commercial game machines, such as a volume control switch, a power supply switch, a power supply lamp, and so on.

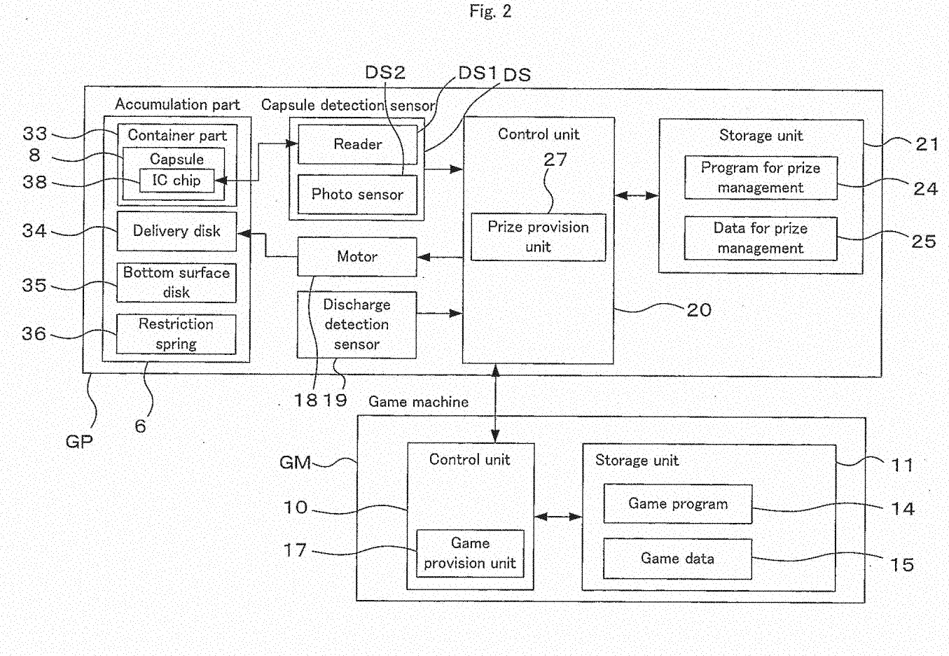

Next, the principal portions of the control system of this game system 1 will be explained. FIG. 2 is a figure showing the principal portions of the control system of the prize discharge mechanism GP and the game machine GM. As shown FIG. 2, a control unit 10 serving as a computer and a storage unit 11 are provided in the game machine GM. The control unit 10 is built as a computer unit in which a microprocessor and peripheral devices of various types such as internal storage devices required for the operation of the microprocessor (for example, ROM and RAM) and so on are combined. As one example, the storage unit 11 is connected to the control unit 10. It should be understood that, in addition to the monitor MO, touch panel TP, and the coin collection mechanism SO which are described above, in a similar manner to the case with other per se known types of game machine, input devices and/or output devices of various types such as a speaker, a card reader (as one example, well-known device which reads information of various types recorded in storage media out of touch, using short distance wireless communication), and so on, may be connected to the control unit 10. However, such devices are not shown in the figure.

The storage unit 11 is capable of maintaining its storage even without supply of any electrical power; for example, it may be built to incorporate a magnetic recording medium, an optical recording medium, a flash SSD (Solid State Drive), or the like. A game program 14 and game data 15 are stored in the storage unit 11. The game program 14 is a computer program that is required in order for the game machine GM to supply a game. Along with execution of the game program 14, a game provision unit 17 is provided in the interior of the control unit 10. This game provision unit 17 executes processing of various types required for provision of the game. The game provision unit 17 is a logical device that is implemented by a combination of computer hardware and a computer program. It should be understood that further logical devices of various types apart from the above may be provided internally to the control unit 10. However, these are not shown in the figures.

The game data 15 is data that can be referred to along with execution of the game program 14. The game data 15 includes, for example, image data, and sound effect data. The image data is data that is needed in order to display images of various types for the game. The sound effect data is data that is needed in order to reproduce sound of various types for the game. It should be understood that, apart from the above, the game data 15 may include data of various types required for providing the game. However, it is not shown in the figures.

On the other hand, as one example, the prize discharge mechanism GP comprises, in addition to the accumulation part 6 described above, a motor 18 serving as a drive source, a discharge detection sensor 19, and a capsule detection sensor DS serving as a prize detection sensor. Further, the prize discharge mechanism GP also comprises a control unit 20 and a storage unit 21. The control unit 20 is built as a computer unit in which a microprocessor and peripheral devices of various types such as internal storage devices required for the operation of the microprocessor (for example, ROM and RAM) and so on are combined. For example, the storage unit 21, the motor 18, the discharge detection sensor 19, and the capsule detection sensor 20 are connected to the control unit 20. It should be understood that, apart from the above, for example, input devices and/or output devices of various types may be connected to the control unit 20. However, such devices are not shown in the figure.

The storage unit 21 is capable of maintaining its storage even without supply of any electrical power; for example, it may be built to incorporate a magnetic recording medium, an optical recording medium, a flash SSD (Solid State Drive), or the like. A program 24 for prize management and data 25 for prize management are stored in the storage unit 11. The program 24 for prize management is a computer program that is required in order for the prize discharge mechanism GP to manage capsules 8. On the other hand, the data 25 for prize management is data that can be referred to along with execution of the program 24 for prize management. Along with execution of the program 24 for prize management, a prize provision unit 27 is provided in the interior of the control unit 20. This prize provision unit 27 executes processing of various types required for managing prizes. The prize provision unit 27 is a logical device that is implemented by a combination of computer hardware and a computer program. It should be understood that further logical devices of various types apart from the above may be provided internally to the control unit 20. However, these are not shown in the figures.

As one example, the accumulation part 6 comprises a container part 33, a delivery disk 34 serving as a first member, a bottom surface disk 35 serving as a second member, and a restriction spring 36 serving as a restriction member. The container part 33 is an upper side part of the accumulation part 6. In concrete terms, the container part 33 is, as one example, a part having space for storing the capsules 8 in the inside. For example, the container part 33 forms circumference and an upper surface of the accumulation part 6. Therefore, the container part 33 includes the front side cover 6a, and the upper side cover 6b described above. That is, in the container part 33, a wall of the front side is formed by the front side cover 6a, and the upper surface is formed by the upper side cover 6b.

The delivery disk 34 is a member for delivering the capsules 8 of the inside of the accumulation part 6 to the discharge part 7. As one example, the delivery disk 34 is arranged on the lower side of the container part 33. In other words, the delivery disk 34 is arranged on the lower side of each capsule 8, for delivering each capsule 8 stored in the container part 33 to the discharge part 7. Further, as one example, the delivery disk 34 is driven rotationally, by the motor 18. And, with a rotation, the delivery disk 34 delivers each capsule 8 located on the lower side in sequence one by one, so that each capsule 8 is discharged one by one from the discharge part 7. The bottom surface disk 35 is a member which is arranged further down the delivery disk 34 so as to assist the delivery of the delivery disk 34. The restriction spring 36 is a spring which is arranged so as to restrict a part of movement of each capsule 8 in the inside of the accumulation part 6.

On the other hand, the capsule detection sensor DS is a sensor for detecting the presence of a delivery of the capsule 8. In concrete terms, as one example, the capsule detection sensor DS is used for detecting a delivery situation of the delivery disk 34. Further, the capsule detection sensor DS includes, for example, a reader DS1 and some photo sensor DS2. The photo sensor DS2 is well-known sensor using light-emitting element emitting infrared and so on. The photo sensor DS2 outputs the detection results to the control unit 20. Further, as one example, operation of the photo sensor DS2 may be controlled by the control unit 20.

On the other hand, the reader DS1 is well-known device for reading information of IC chip (a type of RFID, sometime it is called IC tag). For example, the reader DS1 functions as the capsule detection sensor DS by acquiring information from IC chip. In concrete terms, for example, an IC chip 38 is provided in each capsule 8. For example, in each IC chip 38, there is recorded information of various types needed for management of a prize, such as details including a type of concrete prize stored in each capsule 8 and so on, prize ID for identifying each prize, shipment time, and shipment place. For example, the reader DS1 provides (outputs) the read result from the IC chip 38, that is, acquired information of various types to the control unit 20. And, as one example, the control unit 20 detects a delivery situation of the capsules 8 by the presence of the acquirement of the information from the IC chip 38. In this manner, the reader DS1 functions as the capsule detection sensor DS by the presence of the provision of the information from the IC chip 38. Further, as one example, operation of the reader DS1 may be controlled by the control unit 20.

As described above, the motor 18 is a drive source for driving the delivery disk 34 rotationally. The drive of the motor 18 is controlled by the control unit 20. The discharge detection sensor 19 is a sensor for detecting the presence of the capsule 8 which is discharged from the downside discharge port 7a. For example, the discharge detection sensor 19 may be a well-known sensor detecting the presence of the capsule 8 which passes the downside discharge port 7a. In concrete terms, for example, the discharge detection sensor 19 may have a member which is pushed by the capsule 8 passing the downside discharge port 7a (but it does not block the pass of the capsule 8). Further, the discharge detection sensor 19 may output a signal indicating discharge of a capsule 8 when pushed with the pass of the capsule 8. As one example, the discharge detection sensor 19 may be configured in this manner. Therefore, the discharge detection sensor 19 is arranged near the downside discharge port 7a of the connection path. Further, the detection result of the discharge detection sensor 19 is output to the control unit 20.

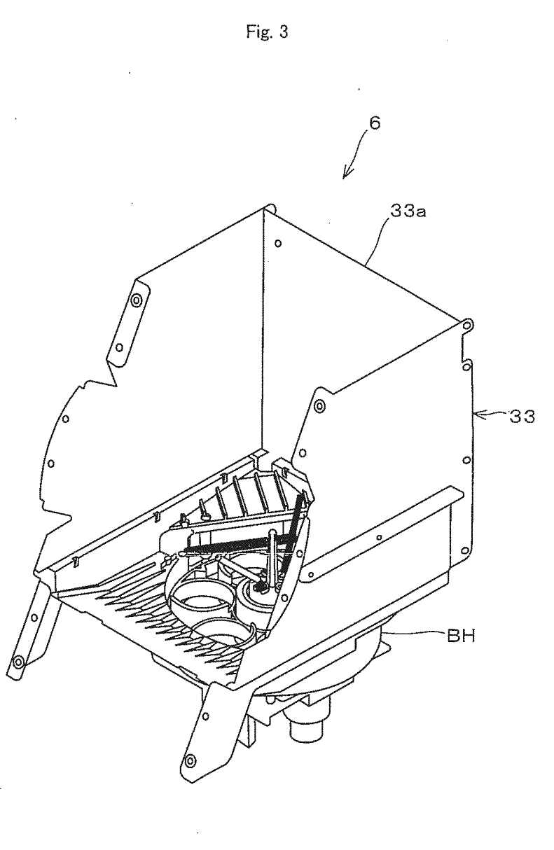

With reference to FIG. 3 to FIG. 8, the prize discharge mechanism GP will be further explained. FIG. 3 is a figure schematically showing an example of a perspective view of the accumulation part 6 in which the front side cover 6a and the upper side cover 6b are removed. As shown in FIG. 3, space for storing a lot of capsules 8 is formed in the inside of the container part 33. Further, for example, the container part 33 has wall part 33a. The wall part 33a is a member forming side walls surrounding the inside space. In concrete terms, the wall part 33a forms surrounding side walls other than a front side wall formed by the front side cover 6a, among the walls forming the inside space of the accumulation part 6. Further, as one example, a tubular part BH extending to the lower side cylindrically is formed, on the lower side of the container part 33.

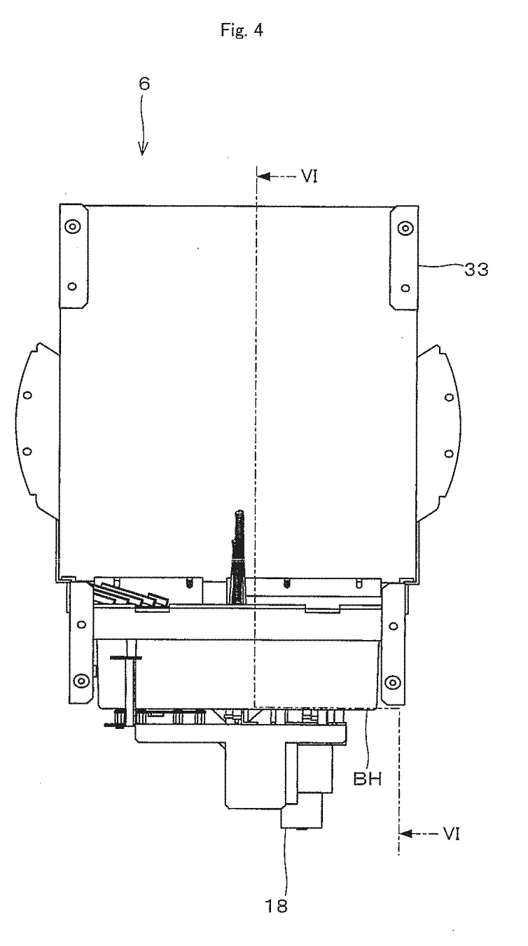

FIG. 4 is a figure schematically showing a front view in the example of FIG. 3, that is, a front view of the accumulation part 6 in which the front side cover 6a and the upper side cover 6b are removed. As shown in FIG. 4, as one example, the motor 18 is arranged on the lower side of the accumulation part 6. In concrete terms, the motor 18 is arranged further down the tubular part BH.

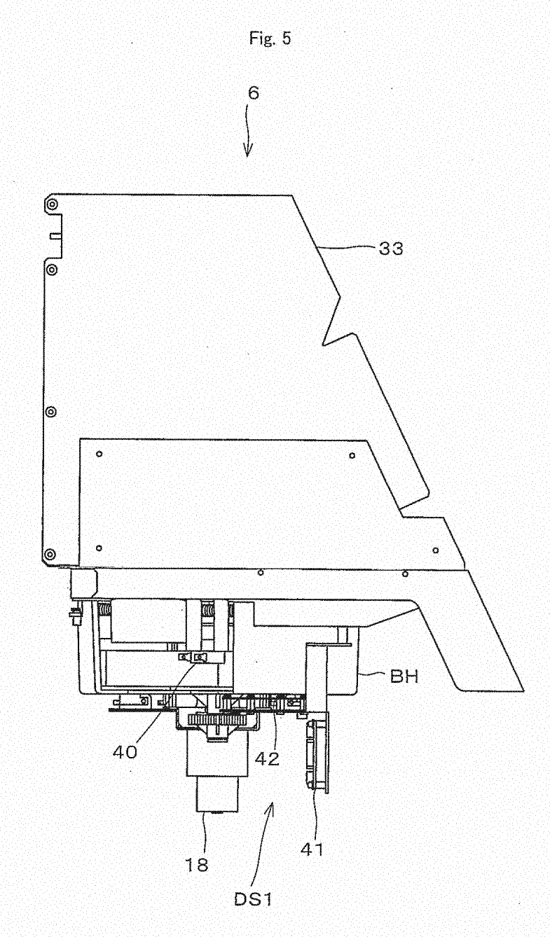

FIG. 5 is a figure schematically showing a left side view in the example of FIG. 3, that is, a left side view of the accumulation part 6 in which the front side cover 6a and the upper side cover 6b are removed. As shown in FIG. 5, as one example, a rotation detection switch 40 and the reader DS1 are further provided on the lower side of the accumulation part 6. For example, the rotation detection switch 40 is a switch for outputting a signal, with a rotation of the delivery disk 34 and so on. As one example, the rotation detection switch 40 functions as a sensor detecting a rotation of the delivery disk 34. That is, for example, the rotation detection switch 40 functions as a unit for acquiring a rotation situation of the delivery disk 34 and so on. As one example, the rotation detection switch 40 outputs information of the detection result, that is the rotation situation of the delivery disk 34 and so on, to the control unit 20.

On the other hand, as one example, the reader DS1 includes an antenna control substrate 41 and an antenna substrate 42. The antenna substrate 42 is a well-known unit for reading the IC chip 38. The antenna control substrate 41 is a well-known unit for controlling operations of the antenna substrate 42. That is, the reader DS1 is arranged so as to read the IC chip 38 in each capsule 8 of the inside of the container part 33, from the further lower side of the tubular part BH.

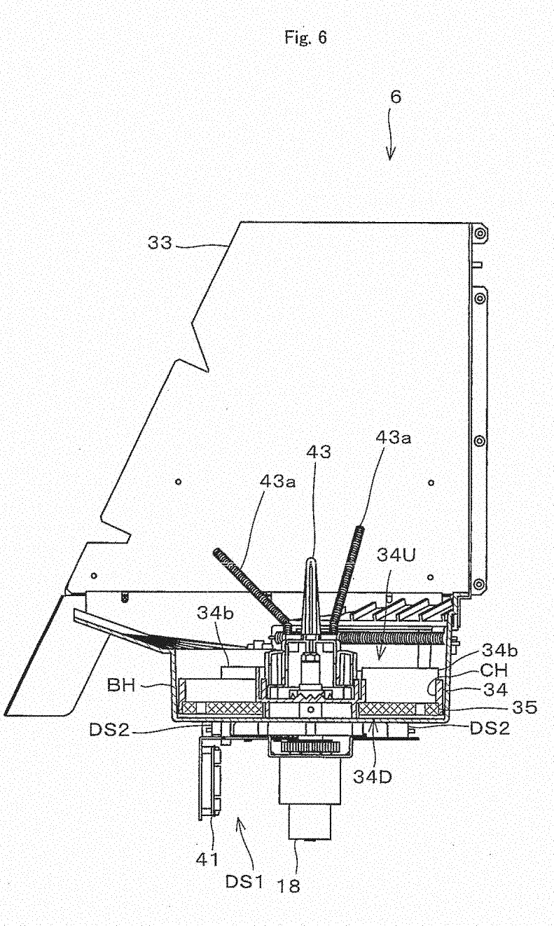

FIG. 6 is a figure schematically showing a cross-section view about VI-VI line in FIG. 4. As shown in FIG. 6, as one example, the photo sensors DS2 are arranged on the lower side of the tubular part BH, in a similar manner to the reader DS1. That is, the reader DS1 and the photo sensors DS2 are arranged on the opposite side of the delivery disk 34 across the bottom surface disk 35. Further, in the inside of the tubular part BH, the delivery disk 34 and the bottom surface disk 35 are arranged in order from the top. As one example, while the delivery disk 34 is arranged so as to be capable of rotating, the bottom surface disk 35 is arranged fixedly so as not to move.

As one example, the delivery disk 34 has a plurality of passage opening parts CH. Each passage opening part CH is a part opening so as to connect the upper surface side 34U and the bottom surface side 34D of the delivery disk 34. In other words, each passage opening part CH is an opening part so that each capsule 8 located on the upper side of the delivery disk 34 can pass to the lower side of the delivery disk 34. Therefore, each passage opening part CH is formed so as to pass through the delivery disk 34 in the thickness (height) direction. Further, each passage opening part CH is formed to a predetermined height (depth) based on the size (radius) of each capsule 8. Furthermore, an extended part 34b is also formed at the part of opening on the upper side of each passage opening part CH. The extended part 34b is a part extending so as to extend the height of each passage opening part CH. As the result, on the upper side of a part of each passage opening part CH, there is formed a part which is higher than other parts.

On the other hand, the bottom surface disk 35 is formed to shape of a board surface so as to follow the bottom surface of the tubular part BH. As the result, the bottom surface disk 35 blocks the lower side of each passage opening part CH, and functions as the bottom surface of each passage opening part CH. That is, the bottom surface disk 35 is arranged so as to block the pass of each capsule 8, and keep each capsule 8 in each passage opening part CH.

Furthermore, a stirring part 43 is provided in the central part of the delivery disk 34 and the bottom surface disk 35. The stirring part 43 is a unit for stirring the capsules 8 in the inside of the accumulation part 6. In concrete terms, as one example, the stirring part 43 is arranged so as to pass through the central parts of the delivery disk 34 and the bottom surface disk 35. And, in a similar manner to the delivery disk 34, the stirring part 43 is driven rotationally by the motor 18. Further, as one example, two springs 43a for stirring are provided on the upper side of the stirring part 43. Each spring 43a for stirring is arranged so as to extend obliquely upward direction intersecting the vertical direction in order to improve stirring efficiency. The springs 43a for stirring rotate with the stirring part 43. That is, the stirring part 43 rotates so as to affect a state (position and so on) of each capsule 8 in the inside of the accumulation part 6 by the springs 43a for stirring.

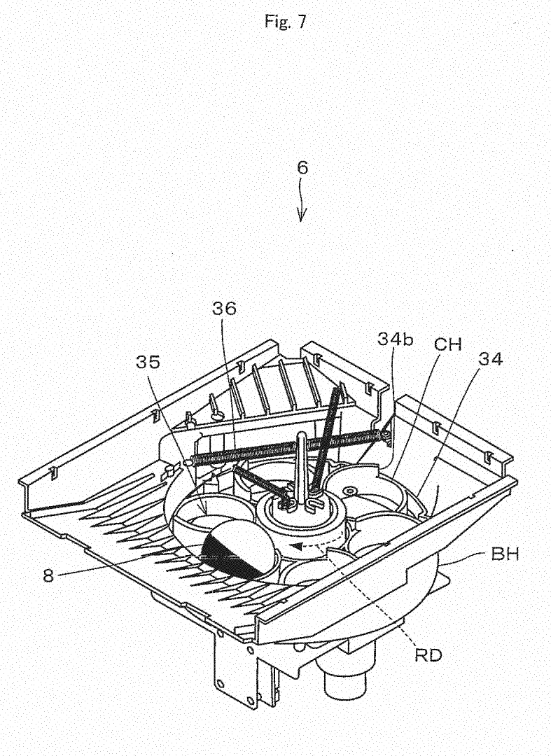

FIG. 7 is a figure schematically showing the accumulation part 6 in which the wall part 33a is removed in the example of FIG. 3. As shown in FIG. 7, as one example, six passage opening parts CH are formed on the delivery disk 34. Further, as one example, each passage opening part CH is formed to a size and shape corresponding to each capsule 8 so that each capsule 8 can pass. In concrete terms, for example, each passage opening part CH is formed to round shape with a size larger than each capsule 8 so that each capsule 8 can pass easily and a plurality of capsules 8 do not enter it. That is, each passage opening part CH is formed to the size and shape in which each capsule 8 passes one by one.

One the other hand, the lower side of each passage opening part CH is blocked by the bottom surface disk 35. Due to this, in each passage opening part CH, a capsule 8 which does not pass and stays there is stored. As the result, when the delivery disk 34 rotates, with the rotation, each passage opening part CH rotates with the capsule 8 which stays there, that is, the capsule 8 which is stored there. Further, the extended part 34b of each passage opening part CH is arranged so as to be located at the back side along with the rotation direction RD of the delivery disk 34. That is, the extended part 34b is provided on the upper side of the opposite side to the rotation direction RD of each passage opening part CH. Therefore, when the delivery disk 34 rotates, the extended part 34b functions so as to assist storing each capsule 8 to each passage opening part CH. As the result, the delivery disk 34 delivers the capsule 8 which is in each passage opening part CH in the rotation direction sequentially through such the passage opening part CH.

Further, the restriction spring 36 is arranged on the upper side of the delivery disk 34. In concrete terms, the restriction spring 36 is arranged so as to cross the upper side of one of the six passage opening parts CH. As the result, the restriction spring 36 restricts entry of the capsules 8 to this one passage opening part CH. One the other hand, the restriction spring 36 is arranged on a position higher than the height of a capsule 8 which is stored in each passage opening part CH. Therefore, the restriction spring 36 does not obstruct the capsules 8 which are located on the lower side and which move with the passage opening parts CH with rotation of the delivery disk 34. That is, the restriction spring 36 is arranged so as to allow movement of the capsules 8 to the lower side with delivery of the delivery disk 34, while restricting the direct entry of the passage opening part CH located on the lower side of it.

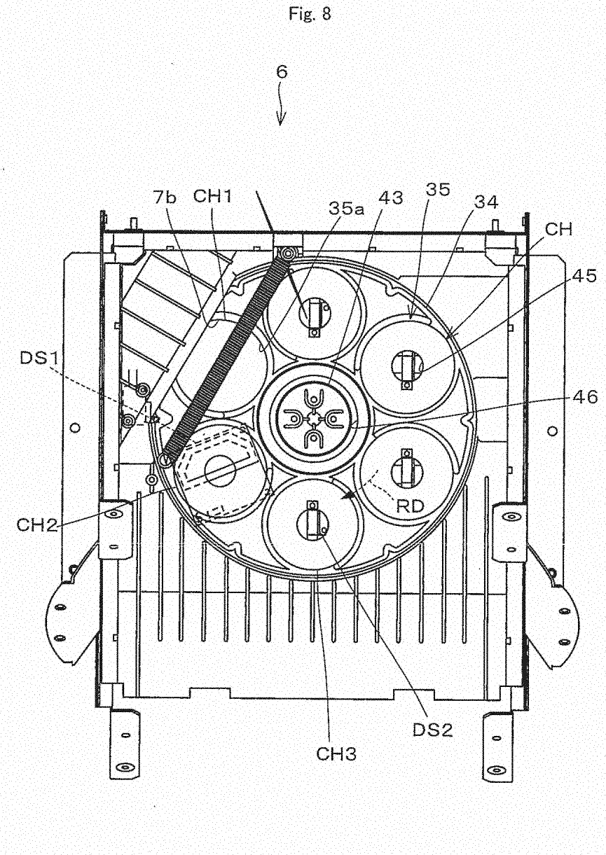

FIG. 8 is a figure schematically showing the plane view of the accumulation part 6 in the example of FIG. 7. However, in the example of FIG. 8, the springs 43a for stirring do not illustrated for the convenience of the explanation. As shown in FIG. 8, as one example, an upper-side discharge port 7b is provided on the lower side of the accumulation part 6. The upper-side discharge port 7b is an opening for discharging the capsules 8 in the inside of the accumulation part 6 to the outside. The upper-side discharge port 7b opens toward the connection path located on the lower side. That is, as described above, the upper-side discharge port 7b is connected to the downside discharge port 7a via the connection path. Further, as one example, in a similar manner to the passage opening part CH, the upper-side discharge port 7b is formed to round shape with a size larger than each capsule 8 so as to discharge one capsule 8, while preventing the entry of other capsules 8.

Similarly, the bottom surface disc 35 has a connection opening part 35a. The connection opening part 35a is an opening part for supplying the upper-side discharge port 7b with the capsules 8. In concrete terms, the connection opening part 35a opens so as to connect the upper side and the lower side of the bottom surface disc 35. Therefore, the upper side of the bottom surface disc 35 is connected to the upper-side discharge port 7b via the connection opening part 35a. And, the connection opening part 35a is arranged on a position corresponding to the upper-side discharge port 7b. As one example, the connection opening part 35a is arranged on the position of the passage opening part CH located on the lower side of the restriction spring 36 (hereafter, this passage opening part CH is described sometime as the connection passage opening part CH1, conveniently).

Further, in a similar manner to the passage opening part CH and so on, the connection opening part 35a is formed to round shape with a size larger than each capsule 8 so as to pass one capsule 8, while preventing the entry of other capsules 8. As the result, the bottom surface disk 35 is formed so as to supply the upper-side discharge port 7b with the capsule 8 which passes through the connection passage opening part CH1 via the connection opening part 35a at the connection passage opening part CH1. On the other hand, as described above, the bottom surface disk 35 is formed so as to block the lower side of each passage opening part CH at the remaining five passage opening parts CH other than the connection passage opening part CH1.

Further, holes 45 for sensor serving as small opening parts are further provided on positions of the remaining five passage opening parts CH other than the connection passage opening part CH1 of the bottom surface disk 35. The holes 45 for sensor are holes which are used for detection of the capsule 8 by the capsule detection sensor DS. In concrete terms, for example, the holes 45 for sensor are holes for the reader DS1 or the photo sensor DS2 to output radio waves or light to the capsule 8 in each passage opening part CH. The holes 45 for sensor open, in a similar manner to the connection opening part 35a, so as to connect the upper side and the lower side of the bottom surface disk 35. However, the holes 45 for sensor are smaller than the connection opening part 35a. In concrete terms, the size of each hole 45 for sensor is much smaller than the diameter of a capsule 8. Duet to this, each capsule 8 can not pass through each hole 45 for sensor. Further, the reader DS1 and the photo sensors DS2 are arranged under the tubular part BH. Therefore, the holes 45 for sensor are also provided in the tubular part BH similarly.

On the other hand, the delivery disk 34 is arranged so that one of the passage opening parts CH corresponds to the position of the upper-side discharge port 7b. That is, the delivery disk 34 is arranged so that one of the passage opening parts CH functions as the connection passage opening part CH1. On the other hand, location of each passage opening part CH changes sequentially with a rotation of the delivery disk 34. Specifically, for example, with this rotation, the location of each passage opening part CH changes so that each passage opening part CH functions as the connection passage opening part CH1 sequentially in the rotation direction RD. In concrete terms, the passage opening part CH one step before the connection passage opening part CH1 in the rotation direction RD (hereafter, conveniently, this is described sometime as next passage opening part CH2) functions as the connection passage opening part CH1 next time. And, the passage opening part CH two steps before the connection passage opening part CH1 in the rotation direction RD (hereafter, conveniently, this is described sometime as third passage opening part CH3) functions sequentially as the connection passage opening part CH1 at the time after next. The same applies to the following each passage opening part CH.

Further, each passage opening part CH rotates with the capsule 8 inside it. As the result, with this rotation, each passage opening part CH delivers the capsule 8 stored inside it to the location of the upper-side discharge port 7b, so as to function sequentially as the connection passage opening part CH1. Further, the connection opening part 35a is provided on the location of the connection passage opening part CH1. Therefore, the connection passage opening part CH1 is different from other passage opening parts CH, and is connected to the upper-side discharge port 7b via the connection opening part 35a. Due to this, each capsule 8 is supplied to the upper-side discharge port 7b at the location of the connection passage opening part CH1. The delivery disk 34 supplies, by such the rotation, the upper-side discharge port 7b with the capsule 8 inside the accumulation part 6 one by one via each passage opening part CH. And, the connection passage opening part CH1 functions as an “one passage opening part” of the claims. Further, the remaining five passage opening parts CH other than the connection passage opening part CH1 function as a “remaining passage opening parts” of the claims.

The capsule detection sensor DS is provided for each passage opening part CH other than the connection passage opening part CH1. That is, five capsule sensors DS corresponding to the five passage opening parts CH respectively are arranged on the lower side of the tubular part BH through the holes 45 for sensor. As one example, the five capsule detection sensor DS comprise one reader DS and four photo sensor DS2. In concrete terms, as one example, the reader DS is arranged at the passage opening part CH one step before the connection passage opening part CH1 in the rotation direction RD, that is, on the lower side of the next passage opening part CH2. Therefore, via the reader DS1, the information recorded in the IC chip 38 of each capsule 8 is acquired at the next passage opening part CH2, in other words, at the location one step before the discharge. On the other hand, the photo sensors DS2 are arranged respectively at the other four passage opening parts CH, that is, at the lower side of the passage opening parts CH other than the connection passage opening part CH1 and the next passage opening part CH2. And, the next passage opening part CH2 functions as a “next passage opening part” of the claims.

Further, an insertion port 46 for the stirring part 43 is formed in the central part of the delivery disk 34 and the bottom surface disk 35. The insertion part 46 is formed so as to pass through the delivery disk 34 and the bottom surface disk 35. The stirring part 43 is inserted into the insertion port 46. Therefore, movement of the capsule 8 at the central part is restricted by the stirring part 43. In concrete terms, entries to the connection passage opening part CH1 from the central part side are prevented. As the result, the capsule 8 which is discharged from the upper-side discharge port 7b is limited to the delivery by the delivery disk 34. As one example, the prize discharge mechanism GP is configured in this manner.

Next, a game which is provided by the game machine GM will be explained. The game machine GM may provide games of various types using the prize discharge mechanism GP. For example, the game machine GM may provide an action game, a role playing game, a simulation game, a puzzle game, a shooter game, and so on. Further, the game machine GM uses, for example, the prize discharge mechanism GP when a prize condition is met. For example, the prize condition may be met according to a play situation of the game. Or, the prize condition may be met by a payment of a predetermined consideration.

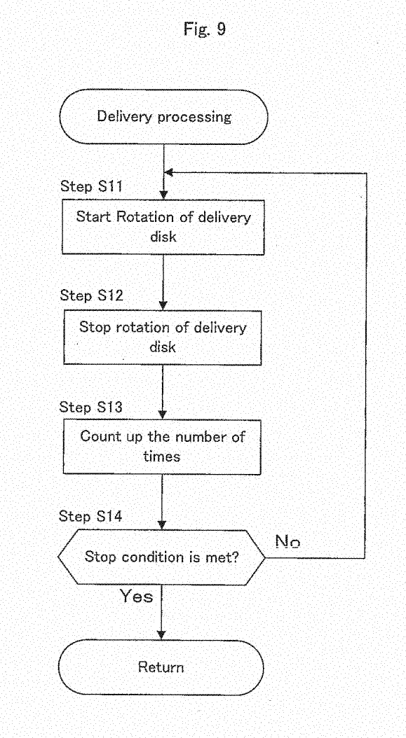

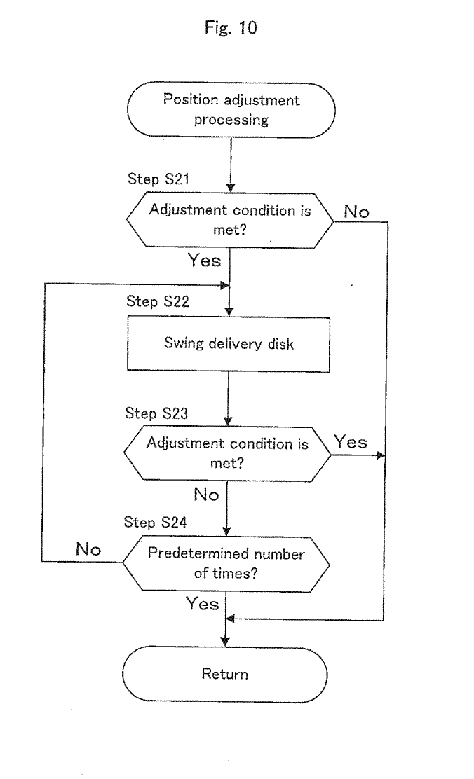

Next, the delivery processing and the position adjustment processing will be explained. The delivery processing is processing for delivering the capsule 8 via the delivery disk 34. In concrete terms, as one example, the delivery processing is executed for controlling rotation of the delivery disk 34 and stop of it. On the other hand, the position adjustment processing is processing for optimizing communication between the reader DS1 and the IC chip 38 of the capsule 8. In concrete terms, the position adjustment processing is executed for swinging the capsules 8 so as to align the capsule 8 with the reader DS1. As one example, the delivery processing is implemented by the control unit 20 via the routine of FIG. 9. And, the position adjustment processing is implemented by the control unit 20 via the routine of FIG. 10. In concrete terms, as one example, the routines of FIG. 9 and FIG. 10 are implemented via the prize provision unit 27 of the control unit 20.

It should be understood that, apart from the processing mentioned above, the control unit 20 and the control unit 10 of the game machine GM may also execute various types of per se known processing and so on, for controlling the prize discharge mechanism GP, or providing the game. Various types of per se known processing using detection results of the reader DS1 and the photo sensors DS2 are included in there. As such processing, the control unit 20 implements, for example, processing for managing stock quantity (for example, whether or not it is five or more). Or, for example, the control unit 10 of the game machine GM implements processing for controlling the game according to the stock quantity (for example, for stopping the use of the prize discharge mechanism GP or stopping the game which is using the prize discharge mechanism GP when there is no stock quantity), and so on. However, detailed explanation thereof will be omitted.

FIG. 9 is a figure showing an example of a flow chart of a delivery processing routine for implementing the delivery processing. As one example, the routine of FIG. 9 is executed when a rotation condition is met. For example, the rotation condition is met when a prize condition is met. That is, as one example, the prize condition may function as the rotation condition.

When the routine of FIG. 9 is started, first in a step S11 the prize provision unit 27 rotates the delivery disk 34. That is, the prize provision unit 27 starts the rotation of the delivery disk 34. In concrete terms, the delivery disk 34 is driven by the motor 18. Therefore, the prize provision unit 27 controls the motor 18 in step S11 so that the delivery disk 34 starts the rotation.

Next in the step S12, the prize provision unit 27 determines whether or not a delivery condition is met, and stops the rotation of the delivery disk 34 when the delivery condition is met. As one example, the delivery condition is met when the passage opening part CH functioning as the connection passage opening part CH1 has been changed. In concrete terms, as one example, the delivery condition is met when the next passage opening part CH has come at the position of the connection passage opening part CH, that is, when the next passage opening has rotate to the position functioning as the connection opening part CH1. Further, as one example, the detection result of the rotation detection switch 40 is used in this determination. That is, as one example, the position in which the next passage opening part CH2 functions as the connection passage opening part CH1 may be detected by the rotation detection switch 40. In concrete terms, for example, on the drive axis for the motor 18 to rotate the delivery disk 34, there may be provided a notification part (not shown) such as a projection and so on, for making the rotation detection switch 40 detect the position in which the next passage opening part CH2 functions as the connection passage opening part CH1. As one example, the rotation detection switch 40 may detect the position of the next passage opening part CH2 by this notification part. Or, the rotation detection switch 40 may detect rotation angle. That is, in the step S12, the prize provision unit 27 stops the rotation of the delivery disk 34 when the next passage opening part CH2 has rotated to the position functioning as the connection passage open part CH1. On the other hand, the prize provision unit 27 continues the rotation of the delivery disk 34 until the delivery condition is met. It should be understood that, for example the delivery condition may be met when the predetermined time has elapsed, in order to prevent the delivery disk 34 from continuing the rotation when it can not detect that the next passage opening part CH2 has come at the position of the connection passage opening part CH1.

In the next step S13, the prize provision unit 27 counts up the number of times that the next passage opening part CH2 rotated to the position functioning as the connection passage opening part CH1. In concrete terms, when this is the first time, it is counted up as “1”. Similarly, when the next passage opening part CH2 has rotated to the position functioning as the connection passage opening part CH1 for the second time, that is when the third passage opening part CH3 next to the next passage opening part CH2 has rotated to the position functioning as the connection passage part CH1, it is counted up as “2”. It is the same after that.

Next in the step S14, the prize provision unit 27 determines whether or not a stop condition is met. For example, the stop condition is met when the capsule 8 has been discharged from the downside discharge port 7a. The discharge of the capsule 8 is judged based on the detection result of the discharge detection sensor 19. That is, the stop condition is met when the capsule 8 has been delivered by the delivery disk 34 definitely. Or, for example, the stop condition may be met when the number of counts has been counted up to “5” based on the count result of step S13. In this case, although the capsule 8 is not delivered by the delivery disk 34 definitely, it is assumed that the capsule 8 has not been stored in any passage opening part CH. That is, it is assumed that there is no stock of the capsule 8. The stop condition is met also in this case.

If the result of the determination in the step S14 is negative, in other words if the stop condition is not met, the prize provision unit 27 returns to the step S11, and executes subsequent processing again. That is, the prize provision unit 27 repeats the processing of the step S11 to the step S13. On the other hand, if the result of the determination in the step S14 is affirmative, in other words if the stop condition is met, the prize provision unit 27 terminates the routine of this time. Due to this, the rotation of the discharge disk 34 is controlled so as to deliver the capsule 8 via each passage opening part CH to the upper-side discharge port 7b. Further, for example, even when the capsule 8 is not stored in the next passage opening part CH2 and so on, the rotation of the discharge disk 34 continues until the passage opening part CH storing the capsule 8 functions as the connection passage opening part CH1. That is, the delivery disk 34 is controlled so as to continue the rotation until the capsule 8 is discharged from the upper-side discharge port 7b. On the other hand, the rotation is stopped even if the capsule 8 is not discharged, after all passage opening parts CH capable of storing the capsule 8 have functioned as the connection passage opening part CH1.

FIG. 10 is a figure showing an example of a flow chart of a position adjustment processing routine for implementation of the position adjustment processing. For example, the routine of FIG. 10 is executed whenever the passage opening part CH functioning as the connection passage opening part CH1 is changed. That is, as one example, the routine of FIG. 10 is executed whenever the delivery condition is met.

When the routine of FIG. 10 is started, in a first step S21, the prize provision unit 27 determines whether or not an adjustment condition is met. For example, the detection result of the capsule detection sensor DS is used in this determination. In concrete terms, as one example, the adjustment condition is met based on the detection result of the reader DS1 among the capsule detection sensors DS when the reader DS1 does not acquire the information of the IC chip 38 of the capsule 8. In other words, the adjustment condition is met when the reader DS1 can not acquire the information of the IC chip 38. If this determination result is negative, in other words if the adjustment condition is not met, the prize provision unit 27 skips the subsequent processing and terminates this routine. It should be understood that, for example, the adjustment condition may further include the detection result of the photo sensors DS2 as a condition. For example, the adjustment condition may be met when store of the capsule 8 is detected by the photo sensors DS2 on the position in which the next passage opening part CH2 functions as the third passage opening part CH3. That is, as one example, the adjustment condition may be met based on the detection results of the photo sensors DS2 and the reader DS1 when the information of the IC chip 38 can not be acquired while the capsule 8 is stored in the next passage opening part CH2.

On the other hand, if the result of the determination in the step S21 is affirmative, in other words if the adjustment condition is met, the prize provision unit 27 proceeds to the step S22. In the step S22, the prize provision unit 27 controls the motor 18 so as to swing the capsules 8. In concrete terms, the prize provision unit 27 drives the delivery disk 34 one time so that the delivery disk 34 rotates in the rotation direction RD and the opposite direction of it within range in which the passage opening part CH functioning as the connection passage opening part CH1 is not changed. For example, the number of times is counted up as one time when the delivery disk 34 rotates in the rotation direction RD and the opposite direction of it, that is, in the front and the back of the rotation direction RD. That is, as one example, in the step S22, the prize provision unit 27 causes the delivery disk 34 to execute a motion to rotate the delivery disk 34 so as to swing it one time in the front and the back of the rotation direction RD.

In the next step S23, the prize provision unit 27 determines whether or not the adjustment condition is met again. That is, the prize provision unit 27 determines again whether or not the information of the IC chip 38 of the capsule 8 has been acquired by the reader DS1. If this determination result is affirmative, in other words if the reader DS1 has acquired the information of the IC chip 38, the prize provision unit 27 skips the subsequent processing and terminates this routine.

On the other hand, if the determination result of the step S23 is negative, in other words if the reader DS1 has not still acquired the information of the IC chip 38, the prize provision unit 27 proceeds to the step S24. In the step S24, the prize provision unit 27 determines whether or not the delivery disk 34 has been swung the predetermined number of times, that is whether or not the number of swing times of the delivery disk 34 is the predetermined number of times. For example, three times may be employed as the predetermined number of times. Therefore, for example, in the step S24, the prize provision unit 27 determines whether or not the motion to rotate the delivery disk 34 in the front and the back of the rotation direction RD has been executed three time, that is whether or not the delivery disk 34 has been swung three time in the front and the back of the rotation direction RD at this routine. If this determination result is negative, in other words if the number of swing times of the delivery disk 34 is not three times, the prize provision unit 27 counts up one time and returns to the step S22. And, the prize provision unit 27 executes the processing described above again in the step S22.

One the other hand, if the result of the determination in the step S24 is affirmative, in other words if the number of swing times that the delivery disk 34 has been swung in the rotation direction is three times, the prize provision unit 27 terminates this routine. Due to this, when the reader DS1 has not acquired the information of IC chip 38, that is when the reader DS1 can not acquire the information of IC chip 38, the delivery disk 34 is driven in the rotation direction RD and the opposite direction of it so as to swing. Further, if the information of IC chip 38 is not acquired even with one time swing, the delivery disk 34 is swung up to three times. On the other hand, even if the information of the IC chip 38 is not acquired, the drive of the delivery disk 34 is stopped with three time swings of the delivery disk 34.

As explained above, according to this embodiment of the prize discharge mechanism GP, each capsule 8 inside the accumulation part 6 is delivered and discharged one by one, by the delivery disk 34. Further, on the lower side of the five passage opening parts CH other than the connection passage opening part CH1, there are provided the capsule detection sensors DS detecting whether or not these are storing the capsules 8. That is, the detection of whether or not each passage opening part CH scheduling the delivery after the next time can deliver the capsule 8, is executed by the capsule detection sensors DS. Therefore, it is possible to detect the stock quantity more than at least five, or the specific stock quantity within five, as the number of the remaining prizes. Due to this, it is possible to manage the stock quantity of prizes including not only next time but also after the next time, specifically, to manage the stock quantity indicating more than five or specific number within five.

Further, the delivery disk is swung, if the reader DS1 can not acquire the information from the IC chip 38 of the capsule 8 at the next passage opening part CH2. The capsule 8 has spherical shape. Therefore, with this swing, the capsule 8 turns around in the next passage opening part CH2. That is, it is possible to turn the capsule 8 around so that the communication between the reader DS1 and the IC chip 38 of the capsule 8 is executed optimally when the reader DS1 can not acquire the information from the IC chip 38. And, this swing is continued up to three times until the information of the IC chip 38 is acquired. Due to this, it is possible to improve accuracy of acquisition of the information in IC chip 38. On the other hand, with the swings of three times of the delivery disk 34, even if the information of the IC chip 38 is not acquired, the drive of the delivery disk 34 is stopped. Therefore, it is possible to prevent the delivery disk 34 from continuing swing when the capsule 8 can not enter the next passage opening part CH2 since the remaining number of the capsules 8 is few, and so on.

Furthermore, the discharge of the capsule 8 is detected by the discharge detection sensor 19. And, the motor 18 is controlled so as to continue the rotation of the delivery disk 34 until the capsule 8 is discharged. Due to this, it is possible to discharge the capsule 8 more definitely. On the other hand, the motor 18 is controlled so as to stop the rotation of the delivery disk 34 when the discharge of the capsule 8 is detected. Or, even if the discharge of the capsule 8 is not detected, the rotation of the delivery disk 34 is stopped after each of all passage opening parts CH capable of storing the capsule 8 functions as the connection passage opening part CH1. Therefore, it is possible to prevent the delivery disk 34 from continuing the rotation when there is no stock quantity.

In the embodiment described above, by executing the routine of FIG. 9 via the prize provision unit 27, the control unit 20 of the prize discharge mechanism GP functions as a “rotation control device” of the Claims. Further, by executing the routine of FIG. 10 via the prize provision unit 27, the control unit 20 of the prize discharge mechanism GP functions as a “drive control device” of the Claims.

The present invention is not to be considered as being limited to the embodiment described above; it may be implemented in various other appropriate ways. For example, in the embodiment described above, the capsule detection sensor DS is arranged so as to detect the presence of the capsule 8 in all of the remaining five passage opening parts CH other than the connection passage opening part CH1. However, the present invention is not limited to this type of embodiment. For example, in the embodiment described above, the prize discharge mechanism GP is connected to two game machines GM. In this case, requests of these two game machines GM are met when two and more stocks are detected, even if discharge is requested from the two game machines GM at the same time. Therefore, for example, the capsule detection sensor DS may be arranged so as to execute the detection for at least a part of the remaining five passage opening parts CH, including the next passage opening part CH2 and the third passage opening part CH3. As the result, the next passage opening part CH2 and the third passage opening part CH3 function as “two passage opening parts” of the claims.

In the embodiment described above, the capsule detection sensor DS includes the reader DS1. However, the present invention is not limited to this type of embodiment. For example, the capsule detection sensor may be configured by only photo sensors, without the reader DS1. And, the opposite would be also acceptable. For example, when a plurality of readers DS1 is employed as the capsule detection sensors DS, it is possible to understand details of the plurality of prizes which is discharged, and so on. Therefore, for example, when the plurality of readers DS1 are arranged so as to target successive passage opening parts CH such as the connection passage opening part CH1 and the next passage opening part CH2, and so on, it is possible to understand the detail of each prize which is discharged and the sequence of it. As the result, for example, when any one of the five passage opening parts CH have a capsule 8 storing a rare prize, it is possible to actualize presentation that improves the expectation, without clarifying exact time, such as “a rare prize will be discharged soon”, and so on. Further, the capsule detection sensor DS is not limited to the reader DS1 or the photo sensor DS2. As far as it can detect the presence of the capsule 8 in each passage opening part CH, sensors of various types may be employed as the capsule detection sensor DS. Therefore, the capsule detection sensor DS may be arranged at adequate position according to the type, not limited to the lower side of the accumulation part 6.

In the embodiment described above, the capsule 8 is used as the prize. However, the prize is not limited to the capsule 8. As the prize, prizes of various types may be employed. Further, the shape, the size, and so on of each passage opening part CH, the connection opening part 35a, each discharge port 7a, or 7b, and so on also may be formed adequately so as to be able to discharge each prize according to the prizes of various types. Furthermore, in the embodiment described above, for example, the delivery disk 34, the bottom surface disk 35, and each discharge port 7a and 7b, are arranged on the lower side of the accumulation part 6 so that the capsule 8 is discharged from the lower side. However, the present invention is not limited to this type of embodiment. For example, the delivery disk 34, the bottom surface disk 35, and the upper-side discharge port 7b may be arranged on a side of the accumulation part 6 so that each prize is discharged from the side, as far as it is possible to discharge each prize one by one.

In a similar manner, the game machine GM is not to be considered as being limited to only being a commercial game machine. As the game machine GM, for example, a stationary type game machine for home use (including a stationary type personal computer that is capable of executing a game), a portable type game machine (including a portable terminal such as a smart phone, a tablet PC, and a portable type personal computer and the like that are capable of executing a game) and so on may be employed, as appropriate. Furthermore, in the embodiment described above, the control unit 10 and the storage unit 11 were provided to the game machine GM. However, the game machine of the present invention is not to be considered as being limited to such a form. For example, the control unit 10 and the storage unit 11 may be provided logically on the network by employing cloud computing. In other words, it would be acceptable for the game machine GM to be built as a terminal that provides and displays the results of processing by the control unit 10 via network of various types.

In the following, examples of the concept of the present invention based upon the details described above are described. It should be understood that, although in the explanation below reference symbols that refer to the attached drawings are included and are written in parentheses in order to make the present invention easier to understand, the present invention is not to be considered as being limited by these reference symbols in any way.

A prize discharge mechanism of the present invention is a prize discharge mechanism (GP) that discharges a plurality of prizes (8) which is accumulated inside an accumulation part (6) from a discharge port (7b) one by one, wherein the prize discharge mechanism comprises: a first member (34) configured to have a plurality of passage opening parts (CH) with size at which the plurality of prizes passes one by one, and be arranged so that one passage opening part (CH1) among the plurality of passage opening parts corresponds to a position of the discharge port; a second member (35) configured to have a connection opening part (35a) opening so that each prize passes, be arranged between the first member and the discharge port so that the connection opening part corresponds to the position of the discharge port, and block remaining passage opening parts other than the one passage opening part so that each prize does not pass and stays in there, a restriction member (36) configured to restrict entry of each prize to the one passage opening part; and a plurality of prize detection sensors (DS) configured to execute detection of whether or not each prize stays, for at least a part of the remaining passage opening parts, and wherein the first member rotates along the second member with a prize which stays in each passage opening part so that each passage opening part functions as the one passage opening part sequentially, and the plurality of prize detection sensors execute, among the remaining passage opening parts, the detection for at least the two passage opening parts (CH2, CH3) which will function as the one passage opening part at next time and at time after next sequentially with a rotation of the first member.

According to the present invention, between the first member and the discharge port, there is provided the second member that has the connection opening part on the position corresponding to the discharge port, and blocks each passage opening part on other positions. That is, each passage opening part of the first member is connected to the discharge port on the position of the connection opening part, and the passage of the prize is blocked by the first member on the other positions. And, the first member rotates so that the position of each passage opening part coincides sequentially with the position of the discharge port. Therefore, with the rotation of the first member, the prize is delivered one by one to the position of the connection opening part sequentially via each passage opening part, and is discharged. Furthermore, the detection of whether or not the prizes are staying in at least passage opening parts which will move to the position corresponding to the connection opening part at next time and at the time after next, is executed by the prize detection sensors. That is, the detection of whether or not each passage opening part scheduling the delivery at next time and at the time after next can deliver the prize, is executed by the prize detection sensors. Therefore, it is possible to detect the stock quantity equal to or more than at least two, as the number of the remaining prizes, via the prize detection sensors. Due to this, it is possible to manage the stock quantity of prizes including not only next time but also after the next time.

The prize detection sensor may be arranged with various kinds of aspects. For example, according to an aspect of the prize discharge mechanism of the present invention, each prize detection sensor may be arranged for each of the part of passage opening parts so that the detection is executed to at least the part of passage opening parts. Further, in this aspect, an IC chip (38) may be provided in each prize, the plurality of prize detection sensors may include a reader (DS1) functioning as a sensor by acquiring information from the IC chip, and the reader may be arranged at a position corresponding to a next passage opening part (CH2) which will function as the one passage opening part at the next time so as to execute the detection for the next passage opening part.

According to the present invention of an aspect in which the plurality of prize detection sensors includes the reader, there may be further included a drive control device (20) configured to drive the first member so as to affect a direction of the prize staying in the next passage opening part, when the reader can not acquire the information from the IC chip. The reader may be not able to acquire the information of the IC chip, depending on the relation between the reader and the direction of the IC chip. In this case, the first member is driven so as to affect the direction of the prize staying in the next passage opening part. That is, it is possible to change the direction of the prize of the acquisition target when the reader can not acquire the information from the IC chip. Due to this, it is possible to improve accuracy of acquisition of the information in IC chip. Further, in this aspect, various kinds of drives may be employed as the drive of the first member. For example, according to an aspect of the prize discharge mechanism of the present invention, the drive control device may drive the first member so that the first member rotates a predetermined number of times in a front and a back of rotation direction (RD) within range in which a passage opening part functioning as the one passage opening part does not change.

Further, various kinds of sensors may be employed as the prize detection sensors. For example, according to an aspect in which each prize detection sensor is provided for each passage opening part, the plurality of prize detection sensors may include at least a photo sensor (DS2), the photo sensor may be arranged at a opposite side of the second member across the first member, and at least one small opening part (45) smaller than each prize may be formed in the first member at a position corresponding to the photo sensor, for the photo sensor.

The detection target of the prize detection sensors may be set as appropriate, as far as including the passage opening parts which will move to the position of the discharge port at next time and at the time after next. For example, according to an aspect of prize discharge mechanism of the present invention, the plurality of prize detection sensors may execute the detection for all of the remaining passage opening parts as at least the part of passage opening parts.

The rotation and the stop of the first member may be controlled as appropriate. For example, according to an aspect of prize discharge mechanism of the present invention, there may be further include a discharge detection sensor (19) configured to detect presence of a prize which is discharged from the discharge port; a drive source (18) configured to rotate the first member; a rotation control device (20) configured to control the drive source, and wherein the rotation control device controls the drive source so as to start a rotation of the first member when a rotation condition is met, and to stop the rotation when a stop condition is met, and the stop condition is met when the discharge detection sensor has detected the discharge of the prize. Further, in this aspect, six passage opening parts may be formed in the first member as the plurality of passage opening parts, even if the discharge of the prize is not detected, if five passage opening parts have rotated so as to function as the one passage opening part sequentially, the stop condition may be met. At the position corresponding to the discharge port, there has been already finished the delivery of the prize on the passage opening part. Further, the entry of a new prize is restricted by the restriction member. Therefore, the delivery of the prize is scheduled by the remaining five passage opening parts. And, when all of these five passage opening parts can not deliver the prize, there is a high possibility that the prize is not left inside the accumulation part. In this case, the rotation of the first member is stopped, even if all of these five passage opening parts can not deliver the prize. Therefore, it is possible to prevent the first member from continuing the rotation when there are no prize stocks.

In the accumulation part, there may be accumulated various kinds of prizes. For example, according to an aspect of prize discharge mechanism of the present invention, all of the plurality of prizes may be formed with spherical shape of capsule type, all of the plurality of passage opening parts and the connection opening part may be opening with round shape corresponding to the spherical shape.

Further, the discharge port and so on may be arranged on various kinds of positions so that the prize is discharged from various kinds of positions. For example, according to an aspect of prize discharge mechanism of the present invention, the first member, the second member, and the discharge port may be arranged on the lower side of the plurality of prizes sequentially so that each prize inside the accumulation part is discharged from the lower side.

What is claimed:

1. A prize discharge mechanism that discharges a plurality of prizes which is accumulated inside an accumulation part from a discharge port one by one, wherein the prize discharge mechanism comprises:
a first member configured to have a plurality of passage opening parts with size at which the plurality of prizes passes one by one, and be arranged so that one passage opening part among the plurality of passage opening parts corresponds to a position of the discharge port;
a second member configured to have a connection opening part opening so that each prize passes, be arranged between the first member and the discharge port so that the connection opening part corresponds to the position of the discharge port, and block remaining passage opening parts other than the one passage opening part so that each prize does not pass and stays in there;
a restriction member configured to restrict entry of each prize to the one passage opening part; and
a plurality of prize detection sensors configured to execute detection of whether or not each prize stays, for at least a part of the remaining passage opening parts, and wherein
the first member rotates along the second member with a prize which stays in each passage opening part so that each passage opening part functions as the one passage opening part sequentially, and
the plurality of prize detection sensors execute, among the remaining passage opening parts, the detection for at least the two passage opening parts which will function as the one passage opening part at next time and at time after next sequentially with a rotation of the first member.

2. A prize discharge mechanism according to claim 1, wherein each prize detection sensor is arranged for each of the part of passage opening parts so that the detection is executed to at least the part of passage opening parts.

3. A prize discharge mechanism according to claim 2, wherein
an IC chip is provided in each prize,
the plurality of prize detection sensors include a reader functioning as a sensor by acquiring information from the IC chip, and
the reader is arranged at a position corresponding to a next passage opening part which will function as the one passage opening part at the next time so as to execute the detection for the next passage opening part.

4. A prize discharge mechanism according to claim 3, further comprising a drive control device configured to drive the first member so as to affect a direction of the prize staying in the next passage opening part, when the reader can not acquire the information from the IC chip.

5. A prize discharge mechanism according to claim 4, wherein the drive control device drives the first member so that the first member rotates a predetermined number of times in a front and a back of rotation direction within range in which a passage opening part functioning as the one passage opening part does not change.

6. A prize discharge mechanism according to claim 2, wherein
the plurality of prize detection sensors includes at least a photo sensor,
the photo sensor is arranged at a opposite side of the second member across the first member, and
at least one small opening part smaller than each prize is formed in the first member at a position corresponding to the photo sensor, for the photo sensor.

7. A prize discharge mechanism according to claim 1, wherein the plurality of prize detection sensors executes the detection for all of the remaining passage opening parts as at least the part of passage opening parts.

8. A prize discharge mechanism according to claim 1, further comprising:
a discharge detection sensor configured to detect presence of a prize which is discharged from the discharge port;
a drive source configured to rotate the first member,
a rotation control device configured to control the drive source, and wherein
the rotation control device controls the drive source so as to start a rotation of the first member when a rotation condition is met, and to stop the rotation when a stop condition is met, and
the stop condition is met when the discharge detection sensor has detected the discharge of the prize.

9. A prize discharge mechanism according to claim 8, wherein
six passage opening parts are formed in the first member as the plurality of passage opening parts,
even if the discharge of the prize is not detected, if five passage opening parts have rotated so as to function as the one passage opening part sequentially, the stop condition is met.

10. A prize discharge mechanism according to claim 1, wherein
all of the plurality of prizes are formed with spherical shape of capsule type,
all of the plurality of passage opening parts and the connection opening part are opening with round shape corresponding to the spherical shape.

11. A prize discharge mechanism according to claim 1, wherein the first member, the second member, and the discharge port are arranged on the lower side of the plurality of prizes sequentially so that each prize inside the accumulation part is discharged from the lower side.
